(19) United States
(12) Patent Application Publication
(10) Pub. No.: US 2018/0033185 A1
(43) Pub. Date: Feb. 1, 2018

(54) TEXTURE MAPPING APPARATUS, TEXTURE MAPPING METHOD, AND COMPUTER READABLE MEDIUM

(71) Applicant: MITSUBISHI ELECTRIC CORPORATION, Tokyo (JP)

(72) Inventors: Satoshi SAKURAI, Tokyo (JP); Mitsuo SHIMOTANI, Tokyo (JP); Tetsuro AKABA, Tokyo (JP); Haruhiko WAKAYANAGI, Tokyo (JP); Natsumi ISHIGURO, Tokyo (JP)

(73) Assignee: Mitsubishi Electric Corporation, Tokyo (JP)

(21) Appl. No.: 15/549,940

(22) PCT Filed: Mar. 25, 2015
(86) PCT No.: PCT/JP2015/059083

§ 371 Date: Aug. 9, 2017

(51) Int. Cl. G06T 15/04; G06T 19/20

(52) U.S. Cl. CPC G06T 15/04; G06T 19/20; G06T 2219/2012

(57) ABSTRACT

Provided are a texture atlas generation unit (10) that generates a texture atlas (41) by combining a plurality of textures, and generates position information (32), in the texture atlas (41), of a texture to be rendered; a polygon information storage unit (330) that stores polygon information (33) in which are set vertex coordinates of the polygon in an output image (42) and vertex texture coordinates corresponding to the vertex coordinates in an image to be rendered on the polygon on the basis of the texture to be rendered; a pixel coordinate calculation unit (22) that detects locations of pixels to be filled in with the polygon in the output image (42), and calculates pixel-corresponding texture coordinates corresponding to locations of pixels in a rendered image; and a coordinate conversion unit (23) that converts the pixel-corresponding texture coordinates to coordinates within an area of the texture to be rendered on the texture atlas (41).

### TECHNICAL FIELD

The present invention relates to a texture mapping apparatus, a texture mapping method, and a program.

### BACKGROUND ART

In computer graphics, a polygon is often used as a primitive for the content to be rendered. In order to express the material of the surface of the polygon, there is a commonly used technique in which the polygon is rendered by mapping a two-dimensional image called a texture to the polygon.

To map the texture to the polygon, there are techniques such as mapping by repeating a small-size texture or mapping by extending the edges of the texture, in order to reduce the amount of memory used. In a commonly used GPU (Graphics Processing Unit), these techniques are called texture wrap modes. The mode in which mapping is performed by repeating is called Repeat, and the mode in which mapping is performed by extending the edges is called Clamp.

When the texture is mapped to the polygon, the polygon is rendered after the texture to be mapped is specified. However, it is known that the process to specify the texture generally takes time, and the processing time is increased if respectively different textures are mapped to a plurality of polygons. Therefore, it is known that rendering can be performed at high speed by combining a plurality of textures into one texture in advance and then mapping a portion thereof to each polygon. A plurality of textures combined into one texture is called a texture atlas. Patent Literature 1 proposes a method for generating a texture atlas at high speed and low load.

### CITATION LIST

### Patent Literature

Patent Literature 1: JP 2013-206094 A

### SUMMARY OF INVENTION

### Technical Problem

However, in the commonly used GPU, when the texture is repeated or clamped, the entirety of the texture is repeated or clamped. Thus, a problem is that the texture to be repeated or clamped cannot be included in the texture atlas.

It is an object of the present invention to perform texture mapping to a polygon by repeating or clamping a part of a texture atlas.

### Solution to Problem

A texture mapping apparatus according to the present invention includes:

a texture atlas generation unit to generate a texture atlas by combining a plurality of textures including a texture to be rendered which is used for rendering on a polygon being a polygonal region, and generate position information indicating a position, in the texture atlas, of the texture to be rendered;

a polygon information storage unit to store polygon information in which vertex coordinates and vertex texture coordinates are set, the vertex coordinates indicating a location of a vertex of the polygon in an output image composed of a plurality of pixels, the vertex texture coordinates indicating a location corresponding to the vertex coordinates in an image to be rendered on the polygon on a basis of the texture to be rendered;

a pixel coordinate calculation unit to detect pixel coordinates indicating pixels corresponding to the polygon in the output image on a basis of the polygon information, and calculate, as pixel-corresponding texture coordinates, coordinates corresponding to the pixel coordinates in the image to be rendered on the polygon; and

a coordinate conversion unit to convert the pixel-corresponding texture coordinates to coordinates within an area including the texture to be rendered combined into the texture atlas, on a basis of the position information, and output the coordinates after being converted as converted coordinates.

### Advantageous Effects of Invention

In a texture mapping apparatus according to the present invention, a polygon information storage unit stores polygon information in which vertex coordinates and vertex texture coordinates are set, the vertex coordinates indicating a location of each vertex of a polygon in an output image, the vertex texture coordinates indicating a location corresponding to the vertex coordinates in an image to be rendered on the polygon. A pixel coordinate calculation unit detects pixel coordinates indicating pixels corresponding to the polygon, and calculates, as pixel-corresponding texture coordinates, coordinates corresponding to the pixel coordinates in the image to be rendered on the polygon. A coordinate conversion unit converts the pixel-corresponding coordinates to coordinates within an area including the texture to be rendered, among the coordinates in the texture atlas, and outputs the coordinates after being converted as converted coordinates. Therefore, the coordinates on the image to be rendered on the polygon by repeating or clamping the texture to be rendered can be converted to the coordinates in the texture atlas. Thus, the texture mapping apparatus provides the effect of being able to perform texture mapping to the polygon by repeating or clamping the texture to be rendered combined into the texture atlas.

### BRIEF DESCRIPTION OF DRAWINGS

FIG. 1 is a block configuration diagram of a texture mapping apparatus according to a first embodiment;

FIG. 2 is a hardware configuration diagram of the texture mapping apparatus according to the first embodiment;

FIG. 3 is a flow diagram illustrating a texture mapping method and a texture mapping process according to the first embodiment;

FIG. 4 is a flow diagram illustrating a texture atlas generation process according to the first embodiment;

FIG. 5 is a diagram illustrating an example of textures according to the first embodiment;

FIG. 6 is a diagram illustrating an example of extended textures according to the first embodiment;

FIG. 7 is a diagram illustrating an example of a texture atlas according to the first embodiment;

FIG. 8 is a diagram illustrating an example of position information according to the first embodiment;

FIG. 9 is a flow diagram illustrating a rendering process according to the first embodiment;

FIG. 10 is a diagram illustrating an example of polygon information according to the first embodiment;

FIG. 11 is a diagram illustrating an area of pixels to be filled in, in accordance with the polygon information illustrated in FIG. 10, in an output image according to the first embodiment;

FIG. 12 is a diagram illustrating an example of a procedure for calculating fragment information of a pixel on the output image according to the first embodiment;

FIG. 13 is a diagram illustrating a result of rendering on the basis of the polygon information of FIG. 10 in the first embodiment;

FIG. 14 is a diagram illustrating an example of a result of rendering when a texture wrap mode is Clamp in the polygon information of FIG. 10 in the first embodiment;

FIG. 15 is a block configuration diagram of a texture mapping apparatus according to a second embodiment;

FIG. 16 is a diagram illustrating an example of a texture atlas according to the second embodiment;

FIG. 17 is a diagram illustrating an example of position information according to the second embodiment;

FIG. 18 is a diagram illustrating a result of rendering on the basis of the polygon information of FIG. 10 in the second embodiment; and

FIG. 19 is a diagram illustrating an example of a result of rendering when the texture wrap mode is Clamp in the polygon information of FIG. 10 in the second embodiment.

### DESCRIPTION OF EMBODIMENTS

### First Embodiment

### Description of Configuration

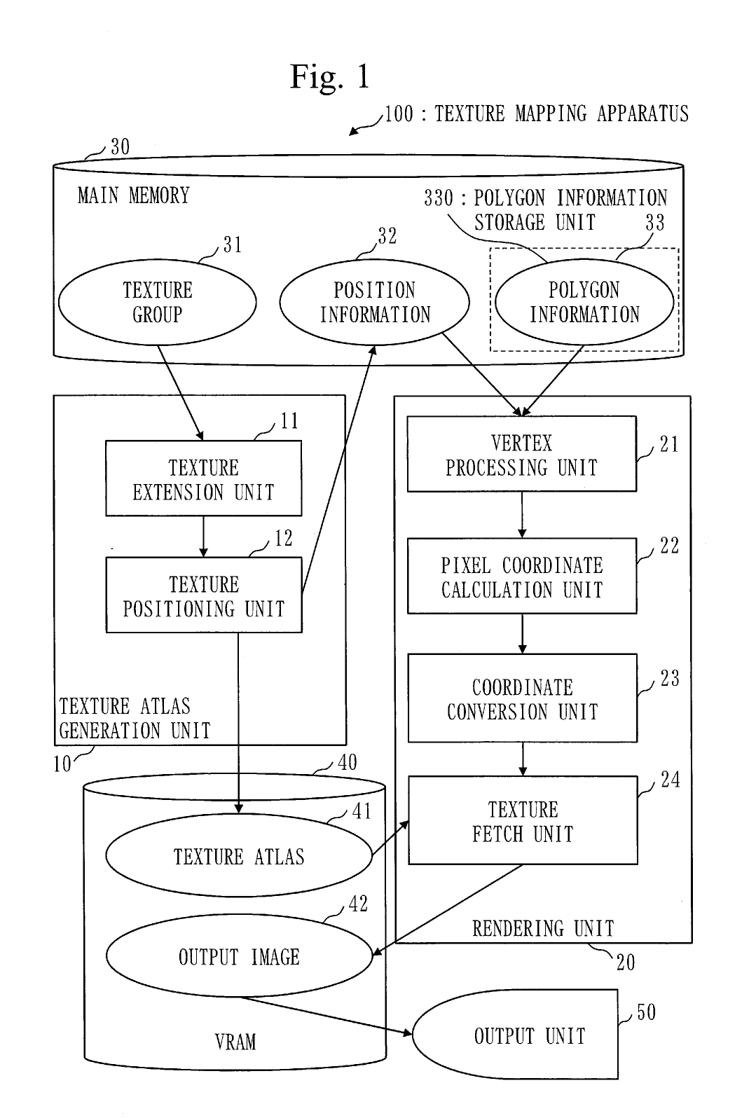

FIG. 1 is a diagram illustrating a block configuration of a texture mapping apparatus 100 according to this embodiment.

As illustrated in FIG. 1, the texture mapping apparatus 100 has a texture atlas generation unit 10, a rendering unit 20, a main memory 30, a VRAM (Video Random Access Memory) 40, and an output unit 50.

The texture atlas generation unit 10 has a texture extension unit 11 and a texture positioning unit 12.

The rendering unit 20 has a vertex processing unit 21, a pixel coordinate calculation unit 22, a coordinate conversion unit 23, and a texture fetch unit 24.

The main memory 30 stores a texture group 31, position information 32, and polygon information 33. The texture group 31 includes a plurality of textures 311.

The VRAM 40 stores a texture atlas 41 and an output image 42.

Note that a texture is also referred to as a texture image.

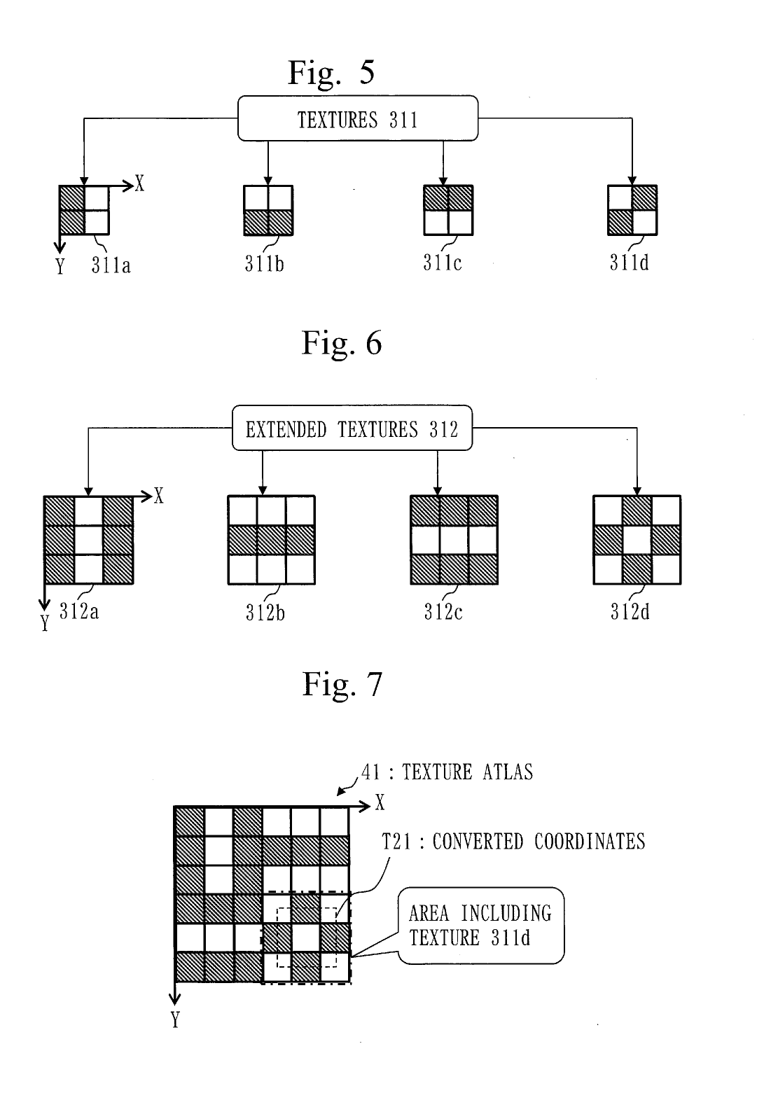

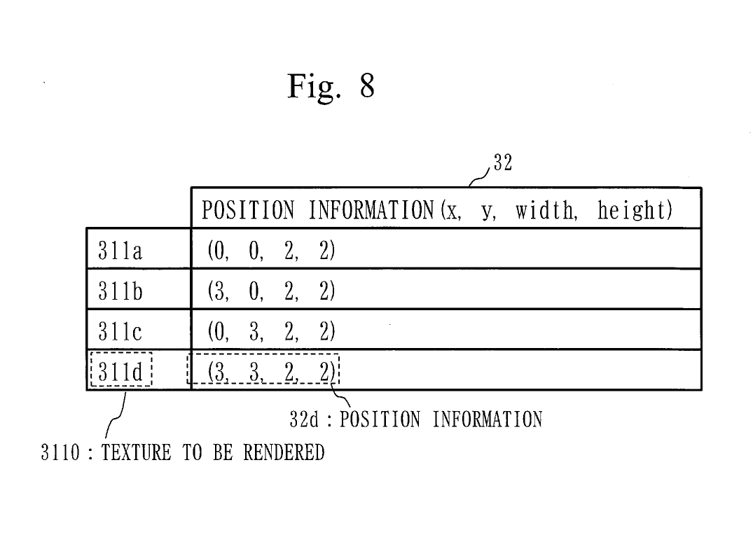

FIG. 5 is a diagram illustrating an example of the textures 311. FIG. 7 is a diagram illustrating an example of the texture atlas 41. FIG. 8 is a diagram illustrating an example of the position information 32.

With reference to FIGS. 1, 5, 7, and 8, the texture atlas generation unit 10 will be briefly described.

The texture atlas generation unit 10 generates the texture atlas 41 by combining a plurality of textures 311 including a texture to be rendered 3110 which is used for rendering on a polygon being a polygonal region. The texture atlas generation unit 10 also generates the position information 32 indicating the position, in the texture atlas 41, of the texture to be rendered 3110. The position information 32 is also referred to as texture position information.

The texture atlas generation unit 10 obtains the texture group 31 stored in the main memory 30, and generates the texture atlas 41 by combining the plurality of textures 311 included in the texture group 31.

The texture extension unit 11 extends each texture 311 of a plurality of input textures. The texture extension unit 11 extends each texture 311 of the plurality of textures by one pixel in each of a longitudinal direction and a lateral direction. That is, the texture extension unit 11 extends each texture 311 of the plurality of textures by one pixel in each of an X-axis direction and a Y-axis direction.

The texture positioning unit 12 generates the texture atlas 41 by combining the textures 311 extended by the texture extension unit 11. The texture positioning unit 12 generates the texture atlas 41 by combining the plurality of textures 311 extended by the texture extension unit 11. An area of each extended texture 311 in the texture atlas 41 is an area including the corresponding texture 311 combined into the texture atlas 41.

The texture positioning unit 12 stores the generated texture atlas 41 in the VRAM 40.

The texture positioning unit 12 also generates the position information 32 indicating the position, in the texture atlas 41, of the texture to be rendered 3110. The texture positioning unit 12 stores the position information 32 indicating the position of each texture 311 in the texture atlas 41 in the main memory 30.

The rendering unit 20 obtains, from the main memory 30, the polygon information 33 and position information 32d of the texture 311 to be mapped to the polygon, that is, the texture to be rendered 3110, among the position information 32. The rendering unit 20 also obtains the texture atlas 41 from the VRAM 40. The rendering unit 20 performs rendering by mapping the texture to be rendered 3110 which is a part of the texture atlas 41 to the polygon by repeating or clamping.

The vertex processing unit 21 obtains, from the main memory 30, the polygon information 33 and the position information 32 of the texture to be rendered 3110 which is to be mapped to the polygon, among the position information 32.

The polygon information 33 is stored in a polygon information storage unit 330 provided in the main memory 30.

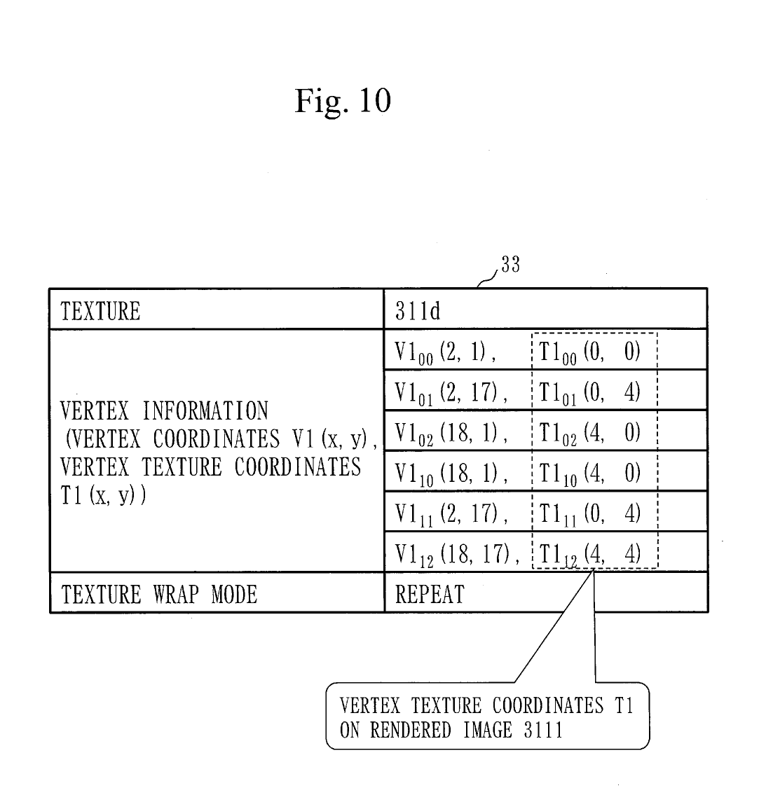

FIG. 10 is a diagram illustrating an example of the polygon information 33. With reference to FIG. 10, the polygon information 33 will be briefly described.

The polygon information storage unit 330 stores the polygon information 33 in which vertex coordinates V1 and vertex texture coordinates T1 are set, the vertex coordinates V1 indicating the location of each vertex of the polygon in the output image 42 composed of a plurality of pixels, the vertex texture coordinates T1 indicating the location corresponding to the vertex coordinates V1 in a rendered image 3111 being an image rendered on the polygon on the basis of the texture to be rendered 3110.

The rendered image 3111 being the image that is rendered on the polygon is a virtual image supposed to be rendered on the polygon on the basis of the texture to be rendered 3110. That is, the vertex texture coordinates T1 are vertex coordinates on the rendered image 3111 that is supposed to be rendered on the polygon on the basis of the texture to be rendered 3110.

In the polygon information 33, either Repeat or Clamp is set as a texture wrap mode.

When the texture wrap mode is Repeat, the vertex texture coordinates T1 in the rendered image 3111 that is supposed to be rendered on the polygon by repeating the texture to be rendered 3110 are set in the polygon information 33.

When the texture wrap mode is Clamp, the vertex texture coordinates T1 in the rendered image 3111 that is supposed to be rendered on the polygon by clamping the texture to be rendered 3110 are set in the polygon information 33.

The pixel coordinate calculation unit 22 detects pixel coordinates V2 indicating pixels corresponding to the polygon in the output image 42, on the basis of the polygon information 33. The pixel coordinate calculation unit 22 calculates coordinates, in the rendered image 3111, which correspond to the pixel coordinates V2 indicating the detected pixels, as pixel-corresponding texture coordinates T2. The pixel-corresponding texture coordinates T2 calculated by the pixel coordinate calculation unit 22 and the pixel coordinates V2 are referred to as fragment information.

The coordinate conversion unit 23 converts the pixel-corresponding texture coordinates T2 to coordinates which are in the texture atlas 41 and which are within an area including the texture to be rendered 3110 combined into the texture atlas 41, on the basis of the position information 32d, and outputs the converted coordinates as converted coordinates T21. The coordinate conversion unit 23 is also referred to as a texture coordinate conversion unit.

The coordinate conversion unit 23 converts the pixel-corresponding texture coordinates T2 to the converted coordinates T21 within the area of the extended texture to be rendered 3110.

The coordinate conversion unit 23 converts the pixel-corresponding texture coordinates T2 to the converted coordinates T21, using a conversion equation in accordance with the texture wrap mode.

The texture fetch unit 24 extracts color information 411 from the texture atlas 41 on the basis of the converted coordinates T21 output by the coordinate conversion unit 23, and fills in the pixels indicated by the pixel coordinates V2 on the basis of the extracted color information 411. The texture fetch unit 24 extracts the color information 411 by interpolating the colors of a plurality of pixels surrounding each pixel indicated by the converted coordinates T21.

The texture fetch unit 24 renders the output image 42 by filling in the pixels on the basis of the color information 411. The texture fetch unit 24 outputs the rendered output image 42 to the VRAM 40.

The output unit 50 outputs the output image 42 in the VRAM 40 to an image display device such as a monitor.

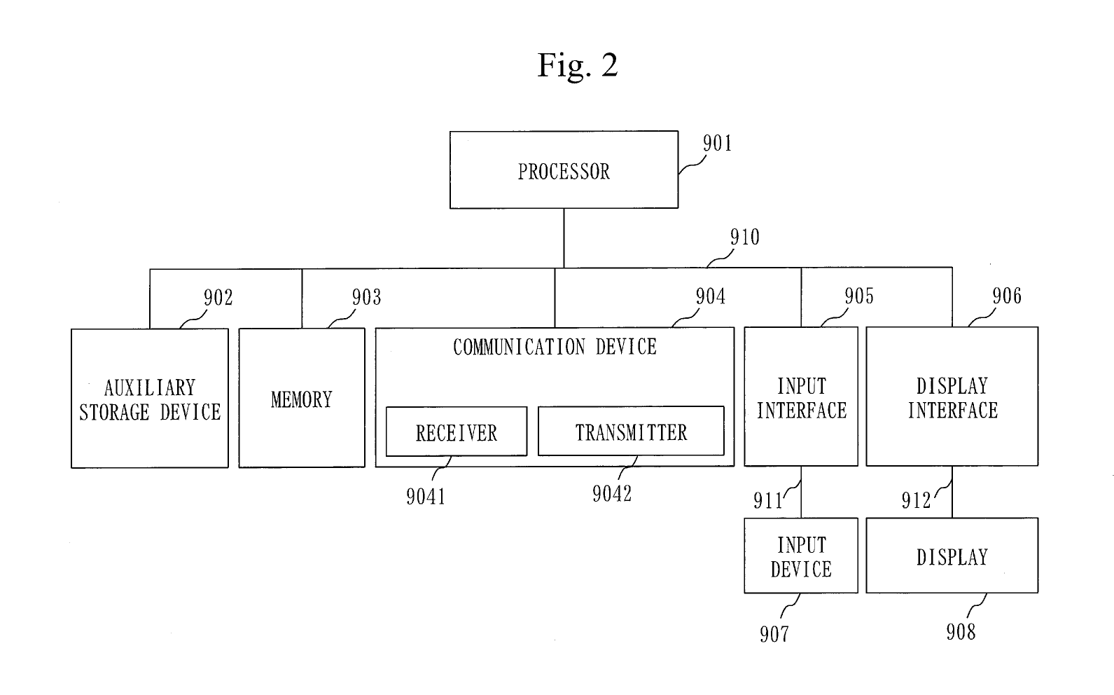

With reference to FIG. 2, an example of a hardware configuration of the texture mapping apparatus 100 according to this embodiment will be described.

The texture mapping apparatus 100 is a computer.

The texture mapping apparatus 100 has hardware, such as a processor 901, an auxiliary storage device 902, a memory 903, a communication device 904, an input interface 905, and a display interface 906.

The processor 901 is connected with the other hardware through a signal line 910, and controls the other hardware.

The input interface 905 is connected to an input device 907.

The display interface 906 is connected to a display 908.

The processor 901 is an IC (Integrated Circuit) that performs processing.

The processor 901 is, for example, a CPU (Central Processing Unit), a DSP (Digital Signal Processor), or a GPU (Graphics Processing Unit).

The auxiliary storage device 902 is, for example, a ROM (Read Only Memory), a flash memory, or an HDD (Hard Disk Drive).

The memory 903 is, for example, a RAM (Random Access Memory).

The communication device 904 includes a receiver 9041 that receives data and a transmitter 9042 that transmits data.

The communication device 904 is, for example, a communication chip or a NIC (Network Interface Card).

The input interface 905 is a port to which a cable 911 of the input device 907 is connected.

The input interface 905 is, for example, a USB (Universal Serial Bus) terminal.

The display interface 906 is a port to which a cable 912 of the display 908 is connected.

The display interface 906 is, for example, a USB terminal or an HDMI (registered trademark) (High Definition Multimedia Interface) terminal.

The input device 907 is, for example, a mouse, a keyboard, or a touch panel.

The display 908 is, for example, an LCD (Liquid Crystal Display).

The auxiliary storage device 902 stores a program to realize the functions of the texture extension unit 11, the texture positioning unit 12, the vertex processing unit 21, the pixel coordinate calculation unit 22, the texture coordinate conversion unit 23, and the texture fetch unit 24 illustrated in FIG. 1. Hereinafter, the texture extension unit 11, the texture positioning unit 12, the vertex processing unit 21, the pixel coordinate calculation unit 22, the texture coordinate conversion unit 23, and the texture fetch unit 24 will be described collectively as the “unit”.

The program to realize the functions of the “unit” described above is also referred to as a texture mapping program. The program to realize the functions of the “unit” may be a single program or may be composed of a plurality of programs.

The program is loaded into the memory 903, and the program is read by the processor 901 and is executed by the processor 901.

Further, the auxiliary storage device 902 stores an OS (Operating System).

At least a part of the OS is loaded into the memory 903, and the processor 901 executes the program to realize the functions of the “unit” while executing the OS.

In FIG. 2, a single processor 901 is illustrated. However, the texture mapping apparatus 100 may have a plurality of processors 901.

The plurality of processors 901 may cooperate with one another to execute the program to realize the functions of the “unit”.

Information, data, signal values, and variable values indicating results of processing by the “unit” are stored in the memory 903 and the auxiliary storage device 902, or in a register or a cache memory in the processor 901.

The “unit” may be provided by “circuitry”.

The “unit” may be replaced by “circuit”, “step”, “procedure”, or “process”. The “process” may be replaced by “circuit”, “step”, “procedure”, or “unit”.

The terms “circuit” and “circuitry” encompass not only the processor 901 but also other types of processing circuits, such as a logic IC, a GA (Gate Array), an ASIC (Application Specific Integrated Circuit), or an FPGA (Field-Programmable Gate Array).

The term “program product” refers to a storage medium, a storage device, or the like in which the program to realize the functions described as the “unit” is recorded. The program product is a product of any appearance in which a computer-readable program is loaded.

### Description of Operation

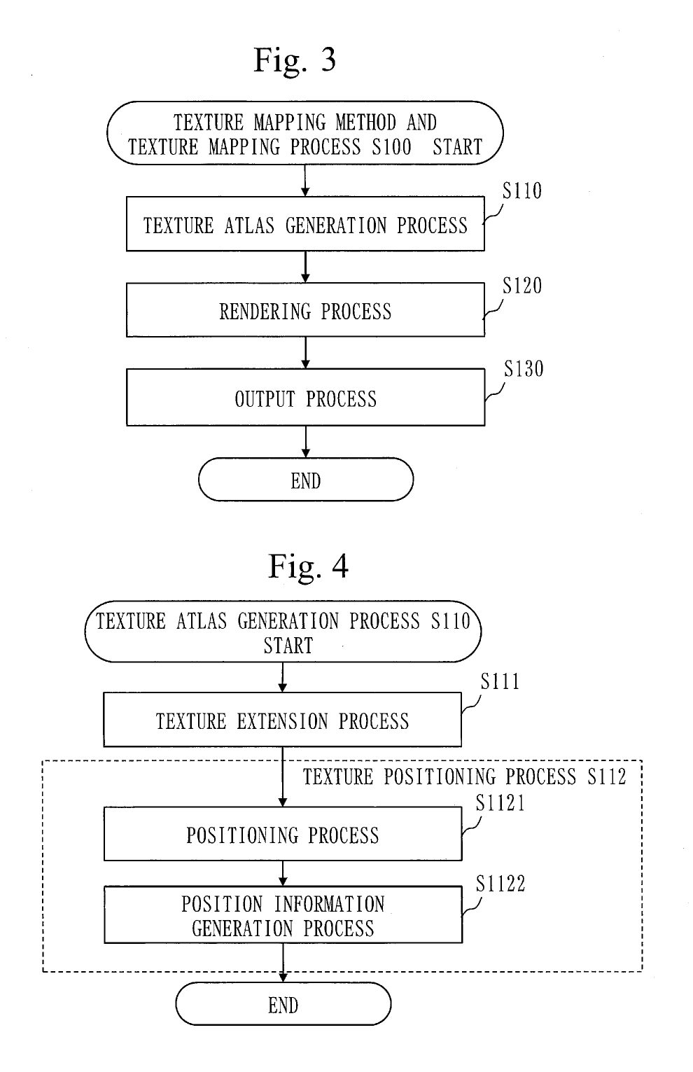

With reference to FIG. 3, a texture mapping method and a texture mapping process S100 of the texture mapping apparatus 100 according to this embodiment will be described.

As illustrated in FIG. 3, the texture mapping process S100 includes a texture atlas generation process S110, a rendering process S120, and an output process S130.

### Texture Atlas Generation Process S110

With reference to FIG. 4, the texture atlas generation process S110 of the texture mapping apparatus 100 according to this embodiment will be described first.

The texture atlas generation unit 10 generates the texture atlas 41 by combining the plurality of textures 311 including the texture to be rendered 3110. The texture atlas generation unit 10 executes the texture atlas generation process S110 to generate the position information 32 indicating the position of the texture to be rendered 3110 in the texture atlas 41.

FIG. 5 illustrates four textures 311a, 311b, 311c, and 311d, each having 2×2 pixels. It is assumed here that the texture 311d is the texture to be rendered 3110 which is used for rendering of the polygon. Each texture 311 may be of any size, and there may be any number of textures 311. In the following description, it is assumed that a direction to the right is an X-axis positive direction and a downward direction is a Y-axis positive direction in each image.

For example, it is assumed that the texture group 31 includes the four textures 311a, 311b, 311c, and 311d.

### Texture Extension Process S111

The texture extension unit 11 obtains the four textures 311a, 311b, 311c, and 311d from the texture group 31.

The texture extension unit 11 extends each of the obtained four textures 311a, 311b, 311c, and 311d by one pixel in each of the X-axis and Y-axis positive directions. At this time, the texture extension unit 11 colors a pixel added for extension using the color of the pixel at the opposite edge in the image. The texture 311 extended by the texture extension unit 11 is referred to as an extended texture 312 herein.

FIG. 6 illustrates extended textures 312a, 312b, 312c, and 312d extended by the texture extension unit 11.

### Texture Positioning Process S112

The texture positioning process S112 has a positioning process S1121 and a position information generation process S1122.

### Positioning Process S1121

The texture positioning unit 12 generates the texture atlas 41 by combining the extended textures 312a, 312b, 312c, and 312d. At this time, the extended textures 312 may be positioned in the texture atlas 41 by any method. As an example of the method for positioning the extended textures 312 in the texture atlas 41, there is a method of solving the two-dimensional bin packing problem, or the like.

FIG. 7 is an example of the texture atlas 41 generated by the texture positioning unit 12. As illustrated in FIG. 7, the texture positioning unit 12 generates the texture atlas 41 by combining the extended textures 312a, 312b, 312c, and 312d to form an image of 6×6 pixels.

The texture positioning unit 12 stores the generated texture atlas 41 in the VRAM 40.

### Position information Generation Process S1122

The texture positioning unit 12 generates the position information 32 indicating the position information of each texture 311. The texture positioning unit 12 stores the generated position information 32 in the main memory 30.

FIG. 8 is a diagram illustrating an example of the composition of the position information 32 according to this embodiment.

In the position information 32, position information (x, y, width, height) is set for each texture 311. The position information 32 is indicated by at least the location (x, y) where the texture 311 is stored and the width and height (width, height) of the texture 311 before being extended by the texture extension unit 11.

Specifically, the position information 32 of the texture 311d being the texture to be rendered 3110 is (3, 3, 2, 2). That is, it is indicated that the location of the texture 311d in the texture atlas 41 is (3, 3) and the width and height of the texture 311d before being extended is (2, 2).

### Rendering Process S120

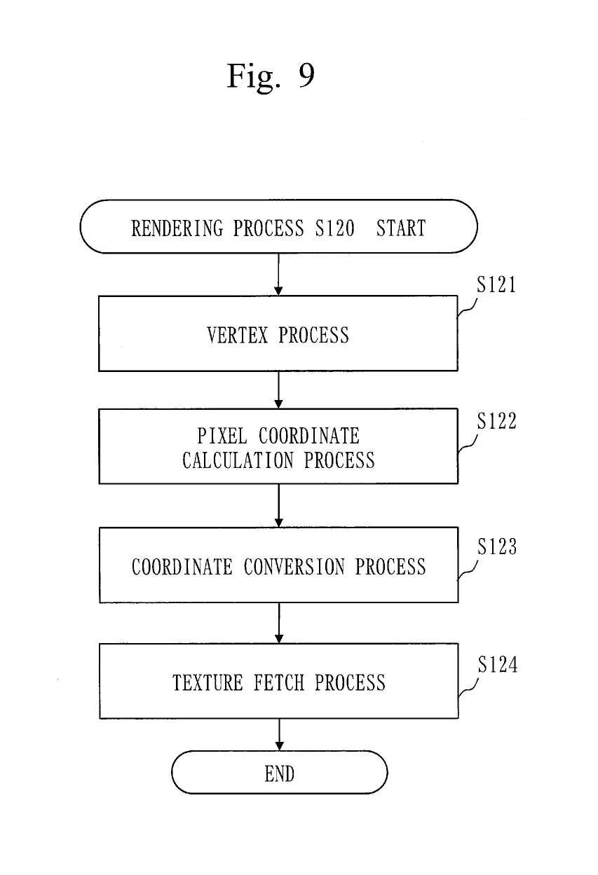

With reference to FIG. 9, the rendering process S120 of the texture mapping apparatus 100 according to this embodiment will now be described.

### Vertex Process S121

The vertex processing unit 21 obtains the polygon information 33 for rendering from the polygon information storage unit 330 of the main memory 30.

FIG. 10 is a diagram illustrating an example of the composition of the polygon information 33 according to this embodiment.

As illustrated in FIG. 10, the polygon information 33 is composed of at least information specifying the texture 311 to be mapped to the polygon, information on each vertex of the polygon, and the texture wrap mode.

Specifically, 311d being an identifier to identify the texture 311d is set in the information specifying the texture to be rendered 3110 which is used for rendering.

In the information on each vertex of the polygon, at least vertex coordinates V1 indicating the location of each vertex constituting the polygon and vertex texture coordinates T1 indicating the location of the texture 311d to correspond to the vertex coordinates V1 are set.

The texture wrap mode is information indicating either Repeat or Clamp.

When the texture wrap mode is Repeat, the rendered image 3111 that is supposed to be rendered by repeating the texture 311d is rendered on the polygon. When the texture wrap mode is Clamp, the rendered image 3111 that is supposed to be rendered by clamping the texture 311d is rendered on the polygon.

That is, the rendered image 3111 signifies an image that is supposed to be rendered on the polygon using the texture to be rendered 3110.

As illustrated in FIG. 10, two polygons are represented by 16×16 pixels, and the rendered image 3111 that is supposed to be rendered on the polygons are represented by 4×4 pixels by the vertex texture coordinates T1. When the texture wrap mode is Repeat, it can be assumed that the rendered image 3111 represented by 4×4 pixels is an image in which a total of four textures 311d of FIG. 5 are arranged in a two-by-two pattern.

The polygon information 33 illustrated in FIG. 10 signifies that the virtual rendered image 3111 represented by 4×4 pixels is drawn on the polygons of 16×16 pixels.

The polygon information 33 of FIG. 10 indicates polygon information when a rectangle is formed by two triangular polygons. The vertex coordinates of each polygon may have three or more dimensions.

The vertex processing unit 21 obtains the position information 32d corresponding to the texture 311d indicated by the polygon information 33 among the position information 32 stored in the main memory 30, on the basis of the information specifying the texture to be rendered 3110 included in the obtained polygon information 33.

When the polygon information 33 of FIG. 10 is used, the vertex processing unit 21 obtains the position information 32d (3, 3, 2, 2) of the texture 311d.

The vertex processing unit 21 performs an arbitrary process on each vertex. For example, this may be a process to apply an arbitrary matrix to the location of the vertex of the polygon, or a process to perform projection conversion on the location of the vertex if the polygon is three-dimensional. It is assumed here that the vertex processing unit 21 directly outputs the polygon information 33.

### Pixel Coordinate Calculation Process S122

The pixel coordinate calculation unit 22 detects pixels corresponding to the polygons in the output image 42, that is, the pixels to be filled in with the polygons, on the basis of the polygon information 33. The pixel coordinate calculation unit 22 executes the pixel coordinate calculation process S122 to calculate coordinates corresponding to the pixel coordinates V2 indicating the location of the detected pixels in the rendered image 3111, as the pixel-corresponding texture coordinates T2. The pixel coordinate calculation process S122 is also referred to a rasterization process.

The pixel coordinate calculation unit 22 detects the pixels to be filled in with the polygons of the polygon information 33 in the output image 42 stored in the VRAM 40.

In FIG. 11, an area of pixels to be filled in, in accordance with the polygon information illustrated in FIG. 10, in the output image 42 of 32×24 pixels is indicated as a shaded region.

The pixel coordinate calculation unit 22 calculates the pixel-corresponding texture coordinates T2 indicating the location corresponding to the pixel coordinates V2 of each detected pixel in the rendered image 3111. The pixel coordinates V2 are, for example, coordinates indicating the center of each pixel.

The pixel coordinate calculation unit 22 calculates the pixel coordinates V2 and the pixel-corresponding texture coordinates T2 corresponding to the pixel, as fragment information.

The pixel coordinate calculation unit 22 calculates the fragment information of each pixel by interpolating the vertex information in accordance with the location of the pixel. Any method of interpolation may be used. For example, it may be calculated by performing liner interpolation on the vertex information on two sides of the triangular polygon, and further performing linear interpolation between the two sides.

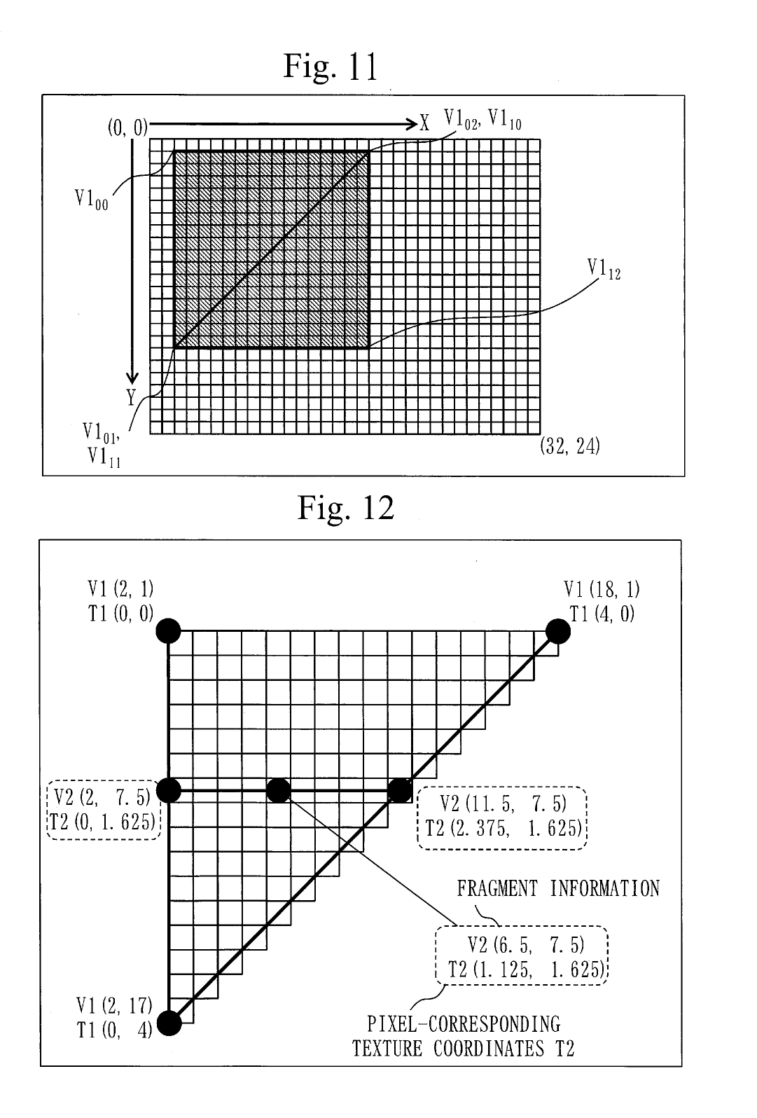

FIG. 12 illustrates an example of a procedure for calculating the fragment information of the pixel indicated by the pixel coordinates V2 (6.5, 7.5) on the output image 42.

### Coordinate Conversion Process S123

On the basis of the position information 32d, the coordinate conversion unit 23 converts the pixel-corresponding texture coordinates T2 to coordinates which are in the texture atlas 41 and which are within an area including the texture to be rendered 3110 combined into the texture atlas 41. Within the area including the texture to be rendered 3110 signifies within the area of the extended texture 312 in the texture atlas 41. That is, the converted coordinates T21 may be coordinates within the extended texture 312d which is an area including the texture to be rendered 3110 and which is obtained on the basis of the texture to be rendered 3110. The coordinate conversion unit 23 executes the coordinate conversion process S123 to output the converted coordinates as the converted coordinates T21.

The coordinate conversion unit 23 converts the pixel-corresponding texture coordinates T2 provided in each piece of fragment information in accordance with the texture wrap mode provided in the polygon information. The conversion equations when the texture wrap mode is Repeat are Equations (1) and (2) below, where (xt, yt) is the pixel-corresponding texture coordinates T2 provided in the fragment information, (Xt, Yt, Wt, Ht) is the position information 32d read by the vertex processing unit 21, and (xt′, yt∝) is the converted coordinates T21.

xt′=Xt+frac((xt+Wt−0.5)/Wt)*Wt+0.5 (1)

yt′=Yt+frac((yt+Ht−0.5)/Ht)*Ht+0.5 (2)

In Equations (1) and (2), frac(a) is an operation to extract the fractional portion of a real number a.

On the other hand, the conversion equations when the texture wrap mode is Clamp are (3) and (4) below.

Xt′=Xt+min(max(0.5, xt), Wt−0.5) (3)

Yt′=Yt+min(max(0.5, yt), Ht−0.5) (4)

In Equations (3) and (4), min(a, b) is an operation to select a smaller one of real numbers a and b, and max(a, b) is an operation to select a larger one of real numbers a and b.

With the above equations, the coordinate conversion unit 23 converts the pixel-corresponding texture coordinates T2 to the converted coordinates T21 which are coordinates in the texture atlas 41 and which are within the area of the extended texture to be rendered 3110. As illustrated in FIG. 7, the converted coordinates T21 are within the area of the extended textures 312d obtained by extending the texture 311d.

In FIG. 7, the area of the converted coordinates T21 is an area which is at a distance of 0.5 pixels from the periphery of the extended texture 312d, that is, the border with the other extended textures 312.

As described above, the area of the converted coordinates T21 is implemented as an area not in contact with the border with the other extended textures 312, in order that the colors of adjacent textures are not mixed when the GPU interpolates colors.

In the examples of FIGS. 5 and 6, the texture extension unit 11 extends each texture by one pixel in each of the X and Y positive directions. Alternatively, each texture may be extended in the negative directions. Note that when each texture is extended in the X-axis negative direction, Equation (5) below is used instead of Equation (1) in the coordinate conversion unit 23.

xt′=Xt+frac((xt+0.5)/Wt)*Wt−0.5 (5)

Similarly, when each texture is extended in the Y-axis negative direction, Equation (6) below is used instead of Equation (2).

yt′=Yt+frac((yt+0.5)/Ht)*Ht−0.5 (6)

The texture extension unit 11 may extend each texture by one pixel in each of the X positive and negative directions and Y positive and negative directions. In this case, either Equations (1) and (2) or Equations (5) and (6) may be used, or Equations (7) and (8) below may be used.

xt′=Xt+frac(xt/Wt)*Wt (7)

yt′=Yt+frac(yt/Ht)*Ht (8)

When each texture is extended by one pixel in each of the X positive and negative directions and Y positive and negative directions, the size of the texture atlas is increased and the memory usage is increased, but the amount of calculation can be reduced by using Equations (7) and (8).

The number of pixels added for extension may be two or more pixels in each of the X positive and negative directions and Y positive and negative directions.

### Texture Fetch Process S124

The texture fetch unit 24 extracts the color information 411 from the texture atlas 41 on the basis of the converted coordinates T21 output by the coordinate conversion unit 23, and fills in the pixels on the basis of the extracted color information 411.

The texture fetch unit 24 obtains, from the texture atlas 41, the color at the location of the converted coordinates T21 corrected by the coordinate conversion unit 23, with regard to each piece of fragment information. At this time, the converted coordinates T21 do not necessarily indicate the center of a pixel in the texture atlas 41, so that the texture fetch unit 24 calculates and obtains the color that is interpolated from the colors of pixels around the location of the converted coordinates T21. Any method of interpolation may be used. For example, bilinear interpolation using the colors of surrounding four pixels may be used. The texture fetch unit 24 fills in the pixels corresponding to the fragment information with the obtained color.

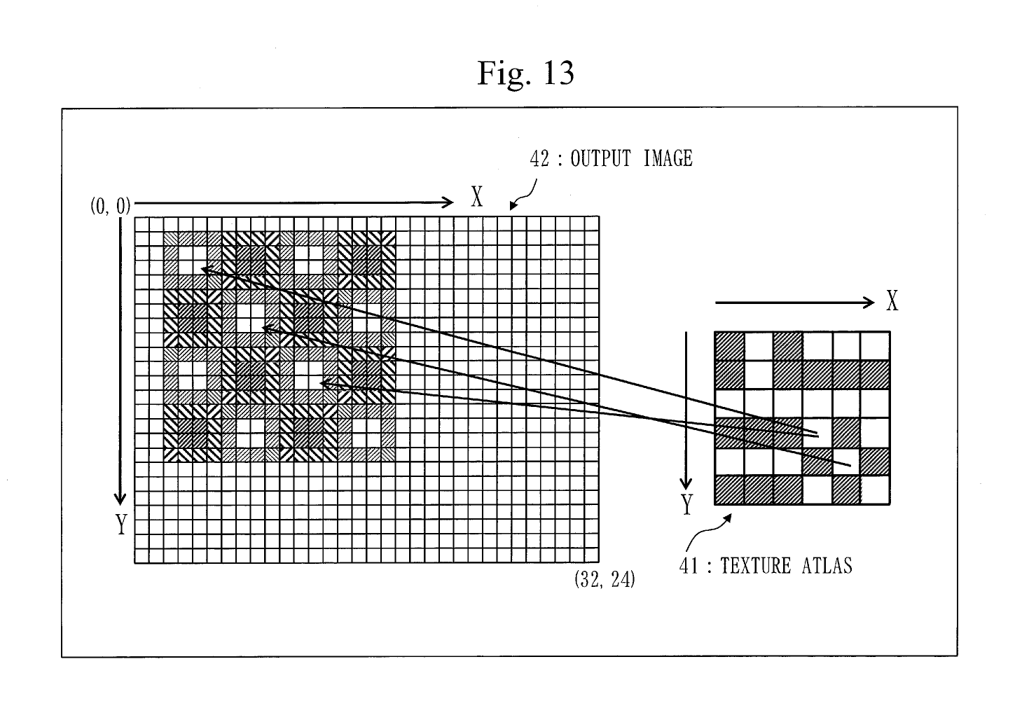

FIG. 13 illustrates a result of rendering the polygon information 33 of FIG. 10 and the locations at which colors are obtained in the texture atlas 41 with regard to some pixels.

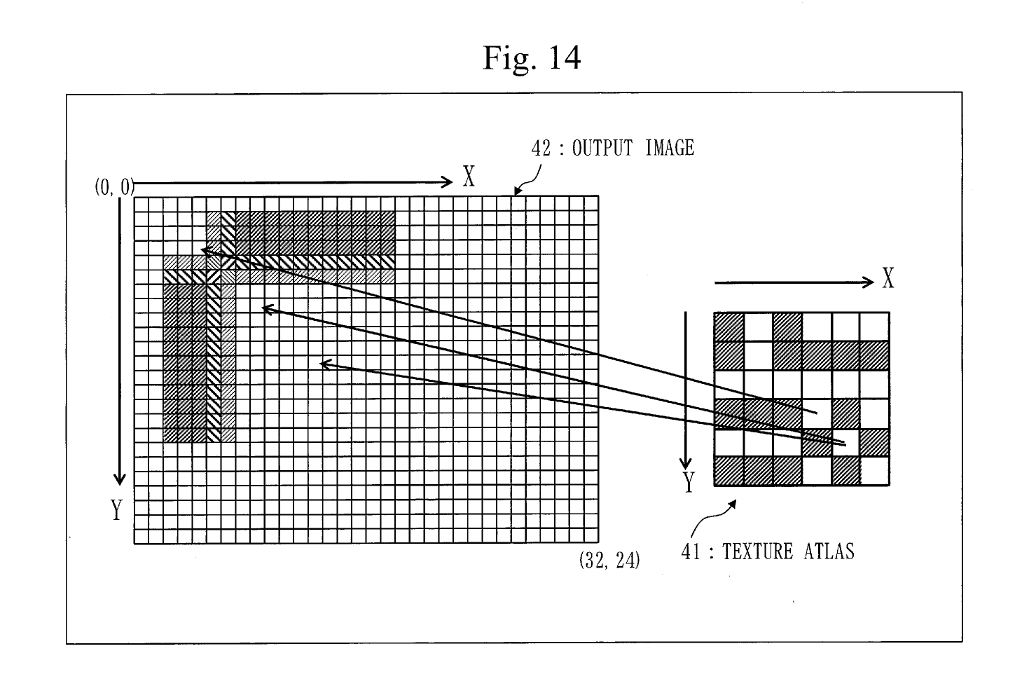

FIG. 14 illustrates an example of a result of rendering when the texture wrap mode is Clamp in the polygon information 33 of FIG. 10.

This completes the description of the rendering process S120.

### Output Process S130

Lastly, the output unit 5 executes the output process S130 to output the output image 42 stored in the VRAM 40 to the image display device such as a monitor.

This completes the description of the texture mapping process S100 of the texture mapping apparatus 100 according to this embodiment.

### Description of Effects

The texture mapping apparatus according to this embodiment does not require a process to specify a texture to be mapped for each polygon when rendering is performed by a mapping a plurality of textures to respectively different polygons. Thus, the texture mapping apparatus according to this embodiment can perform rendering at high speed, and can obtain substantially the same result as that obtained by mapping the original texture by repeating or clamping.

### Second Embodiment

In this embodiment, differences from the first embodiment will be mainly described.

In the first embodiment, the texture extension unit 11 needs to extend the texture 311 at least by one pixel in each of the X-axis and Y-axis directions. As a result, the size of the texture atlas 41 is increased, and the usage of the VRAM 40 is increased.

In this embodiment, therefore, a texture fetch unit 24 uses the color of a pixel most adjacent to the location indicated by converted coordinates T21, instead of interpolating the colors of pixels around the location indicated by the converted coordinates T21. With this process, it is not necessary to extend textures 311 and an increase in the usage of a VRAM 40 can be prevented.

### Description of Configuration

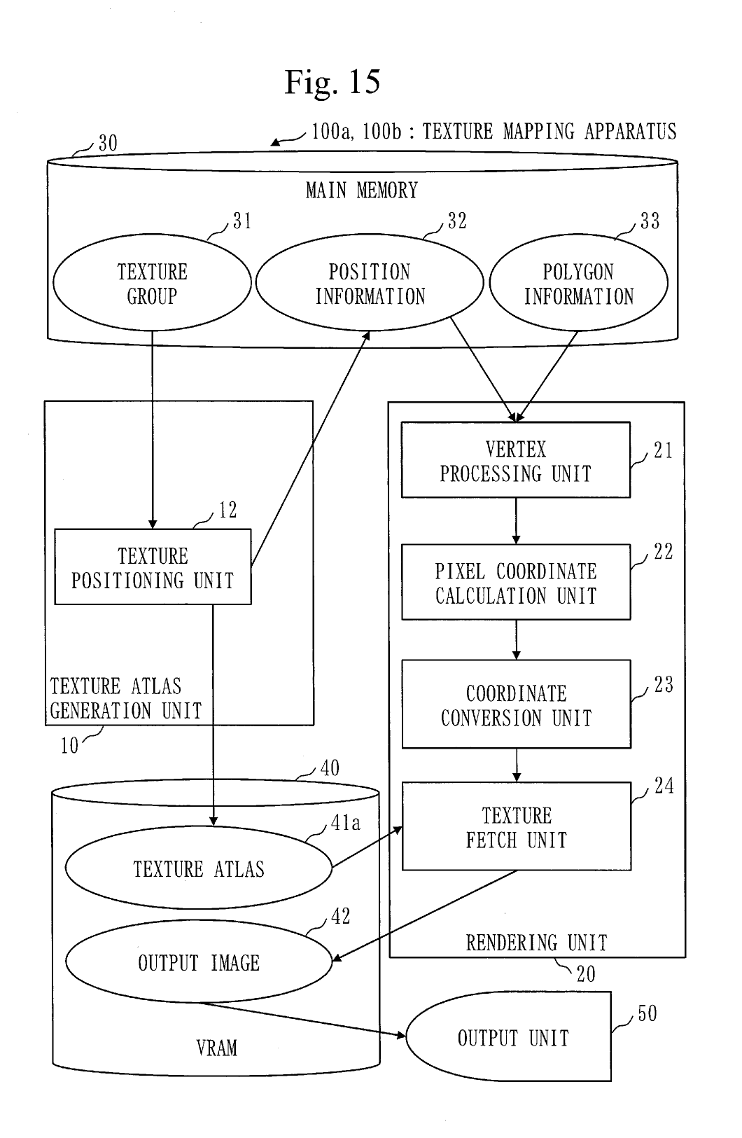

FIG. 15 is a diagram illustrating a block configuration of a texture mapping apparatus 100a according to this embodiment. FIG. 15 is a diagram corresponding to FIG. 1 described in the first embodiment.

In this embodiment, components having substantially the same functions as the components described in the first embodiment are given the same reference numerals, and description thereof may be omitted.

Compared with FIG. 1, FIG. 15 does not include a texture extension unit 11.

A texture atlas generation unit 10 obtains a texture group 31 stored in a main memory 30, and generates a texture atlas 41a by combining a plurality of obtained textures 311. The texture atlas generation unit 10 stores the generated texture atlas 41a in the VRAM 40. The texture atlas generation unit 10 stores, in the main memory 30, position information 32 indicating the position of each texture 311 in the texture atlas 41a.

A rendering unit 20 obtains, from the main memory 30, polygon information 33 and position information of a texture to be rendered 3110, which is a texture to be mapped, among the position information 32, and obtains the texture atlas 41a from the VRAM 40.

The rendering unit 20 performs rendering by mapping a part of the texture atlas 41a to a polygon on an output image 42 by repeating or clamping, and outputs it to the VRAM 40 as the output image 42. At this time, the texture fetch unit 24 extracts, as color information 411, information indicating the color of a pixel nearest to the location indicated by the converted coordinates T21. That is, the texture fetch unit 24 uses the color of a pixel most adjacent to the location indicated by the converted coordinates T21.

The converted coordinates T21 are within an area including the texture to be rendered 3110 in the texture atlas 41. In this embodiment, the area including the texture to be rendered 3110 in the texture atlas 41 is the entirety of the area of the texture to be rendered 3110.

An output unit 50 outputs the output image 42 rendered on the VRAM 40 to an image display device such as a monitor.

### Description of Operation

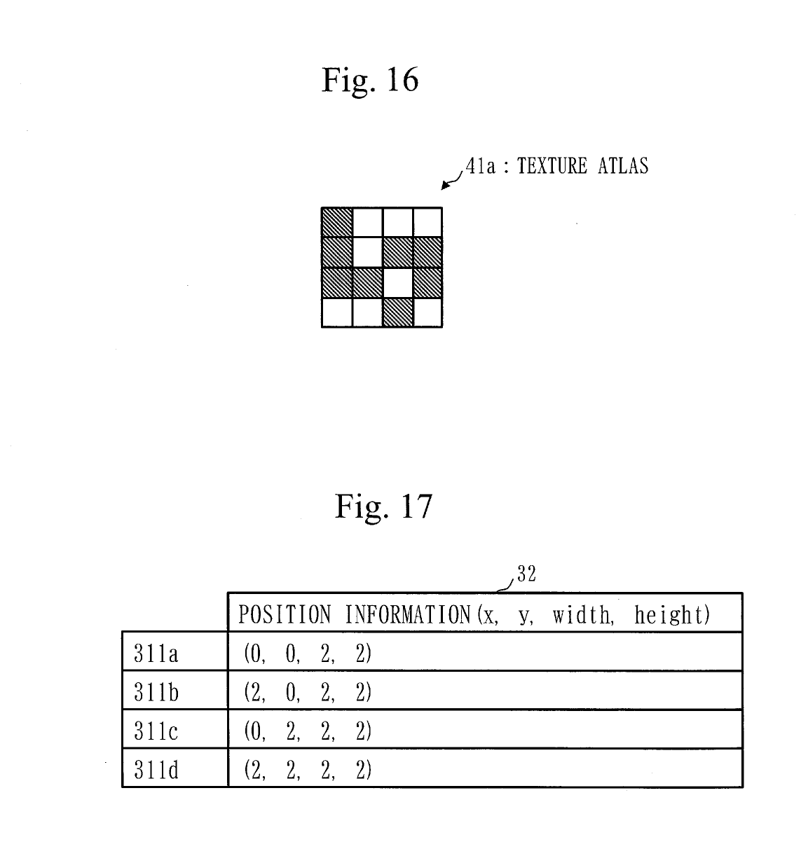

With reference to FIGS. 16 and 17, the process of the texture atlas generation unit 10 will be described.

The operation of a texture positioning unit 12 is substantially the same as that of the texture positioning unit 12 in the first embodiment. As an example, FIG. 16 illustrates a result of generating the texture atlas 41a from the textures 311a, 311b, 311c, and 311d of FIG. 5. FIG. 17 illustrates the position information 32 of the texture atlas 41a illustrated in FIG. 16.

As illustrated in FIG. 16, the textures 311a, 311b, 311c, and 311d are combined in the original size without being extended. When the texture to be rendered 3110 is the texture 311d as in the first embodiment, the position information of the texture 311d is (2, 2, 2, 2).

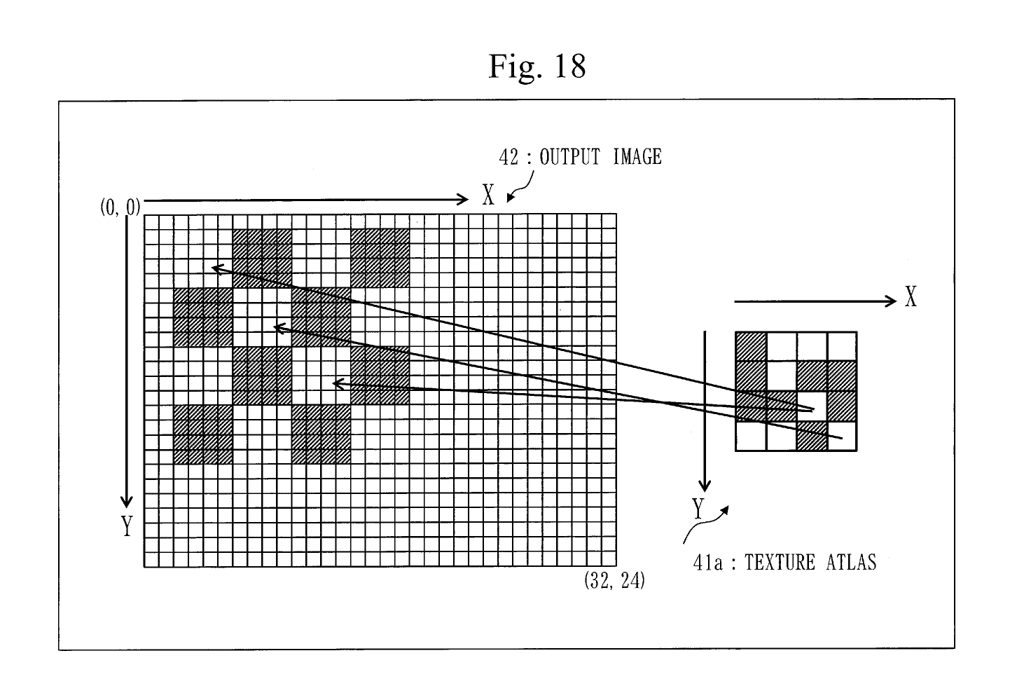

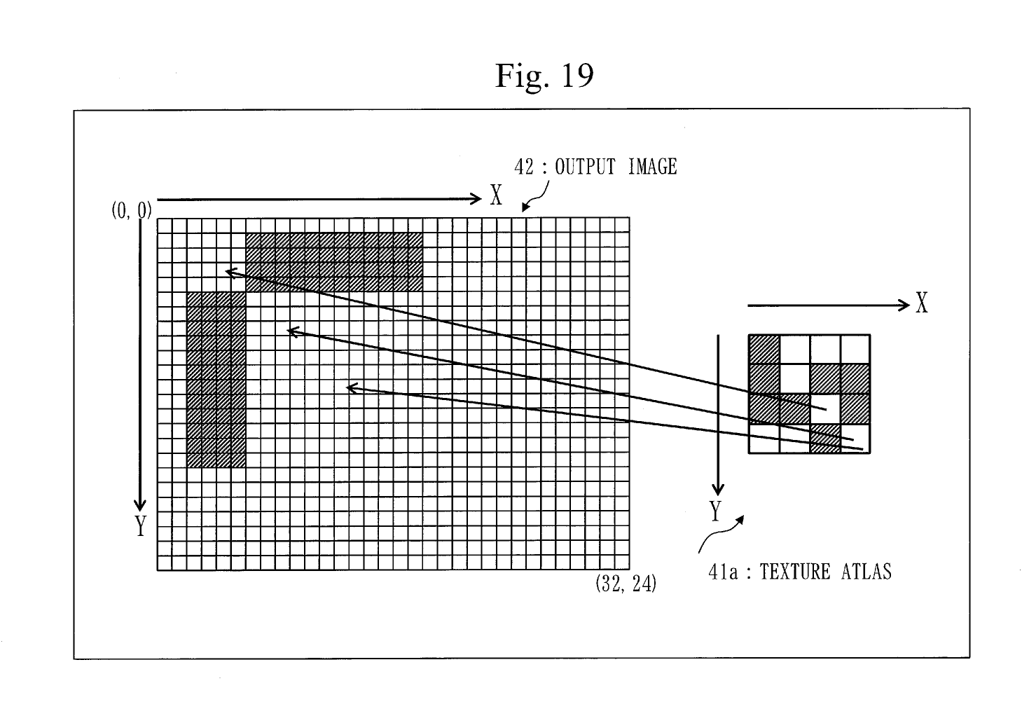

With reference to FIGS. 18 and 19, the process of the rendering unit 20 will be described. The operation of a vertex processing unit 21 and a pixel coordinate calculation unit 22 is substantially the same as in the first embodiment, and detected pixels and generated fragment information are also substantially the same as in the first embodiment.

The coordinate conversion unit 23 converts pixel-corresponding texture coordinates T2 provided in each piece of fragment information, in accordance with the texture wrap mode provided in the polygon information 33.

The conversion equations when the texture wrap mode is Repeat are Equations (9) and (10) below.

xt′=Xt+frac(xt/Wt)*Wt (9)

yt′=Yt+frac(yt/Ht)*Ht (10)

In the above, (xt, yt) is the pixel-corresponding texture coordinates T2, (Xt, Yt, Wt, Ht) is the position information 32 read by the vertex processing unit 21, and (xt′, yt′) is the converted coordinates T21. In Equations (9) and (10), frac(a) is an operation to obtain the fractional portion of a real number a.

On the other hand, the conversion equations when the texture wrap mode is Clamp are (11) and (12) below.

Xt′=Xt+min(max(0, xt), Wt) (11)

Yt′=Yt+min(max(0, yt), Ht) (12)

In Equations (11) and (12), min(a,b) is an operation to select a smaller one of real numbers a and b, and max(a,b) is an operation to select a larger one of real numbers a and b.

The texture fetch unit 24 obtains, from the texture atlas 41a, the color of the location of the converted coordinates T21 calculated by the coordinate conversion unit 23 with regard to each piece of the fragment information. At this time, the texture fetch unit 24 obtains the color of a pixel whose center is nearest to the converted coordinates T21, among the pixels in the texture atlas 41a. The texture fetch unit 24 fills in the pixel corresponding to the fragment information with the obtained color.

FIG. 18 illustrates a result of rendering the polygon information 33 of FIG. 10 and illustrates the locations where colors are obtained in the texture atlas 41a with regard to some pixels. FIG. 19 illustrates an example of a result of rendering when the texture wrap mode is Clamp in the polygon information 33 of FIG. 10.

Lastly, the output unit 50 outputs the output image 42 stored in the VRAM 40 to the image display device such as a monitor.

### Description of Effects

The texture mapping apparatus according to this embodiment does not require a process to switch textures when rendering is performed by mapping a plurality of textures to a plurality of polygons, so that the texture mapping apparatus can perform rendering at high speed. Furthermore, the texture mapping apparatus according to this embodiment can obtain substantially the same result as that obtained by mapping the original texture by repeating or clamping. Furthermore, the texture mapping apparatus according to this embodiment does not need to extend textures when generating a texture atlas, so that an increase in the memory usage can be prevented.

### Third Embodiment

In this embodiment, differences from the first and second embodiments will be described.

In the first embodiment, the texture extension unit 11 needs to extend each texture 311 by at least one pixel in each of the X-axis and Y-axis directions. As a result, the size of the texture atlas 41 is increased, and the usage of the VRAM 40 is increased.

This embodiment describes a texture mapping apparatus wherein the texture wrap mode to be used is only Clamp, and extension of textures is not required and an increase in the memory usage can be prevented.

### Description of Configuration

The configuration of a texture mapping apparatus 100b according to this embodiment is substantially the same as the configuration of FIG. 15 described in the second embodiment.

In this embodiment, components having substantially the same functions as the components described in the first and second embodiments are given the same reference numerals, and description thereof may be omitted.

### Description of Operation

The process of a texture atlas generation unit 10 is substantially the same as in the second embodiment.

The process of a rendering unit 20 will be described.

The operation of a vertex processing unit 21 and a pixel coordinate calculation unit 22 is substantially the same as in the first and second embodiments, and detected pixels and generated fragment information are also substantially the same as in the first and second embodiments.

However, since the texture wrap mode is only Clamp, the texture wrap mode is not required in the polygon information 33 according to this embodiment.

A coordinate conversion unit 23 converts pixel-corresponding texture coordinates T2 provided in each piece of the fragment information to converted coordinates T21, using Equations (3) and (4) described in the first embodiment.

The process of a texture fetch unit 24 is substantially the same as in the first embodiment.

Lastly, an output unit 50 outputs an output image stored in a VRAM 40 to an image display device such as a monitor.

### Description of Effects

The texture mapping apparatus according to this embodiment does not require a process to switch textures when rendering is performed by mapping a plurality of textures to a plurality of polygons, so that the texture mapping apparatus can perform rendering at high speed. Furthermore, the texture mapping apparatus according to this embodiment can obtain substantially the same result as that obtained by mapping the original texture by repeating or clamping. Furthermore, the texture mapping apparatus according to this embodiment does not need to extend textures when generating a texture atlas, so that an increase in the memory usage can be prevented.

In the above embodiments, the texture mapping apparatus is configured such that the texture extension unit 11, the texture positioning unit 12, the vertex processing unit 21, the pixel coordinate calculation unit 22, the texture coordinate conversion unit 23, and the texture fetch unit 24 are implemented as independent functional blocks. However, the configuration of the texture mapping apparatus may be different from the configuration as described above, and may be any configuration.

For example, the texture extension unit 11 and the texture positioning unit 12 may be implemented as one functional block, and the vertex processing unit 21, the pixel coordinate calculation unit 22, the coordinate conversion unit 23, and the texture fetch unit 24 may be implemented as one functional block. The functional blocks of the texture mapping apparatus may be implemented in any manner, as long as the functions described in the above embodiments are realized. A communication apparatus may be configured by implementing these functional blocks in any combination or in any block configuration.

The texture mapping apparatus may be a communication system constituted by a plurality of apparatuses, instead of being one apparatus.

The first to third embodiments have been described. Some of these three embodiments may be implemented in combination. Alternatively, one embodiment of these three embodiments may be implemented partially. Alternatively, these three embodiments may be implemented entirely or partially in any combination.

The above embodiments are essentially preferable examples, and are not meant to restrict the scopes of the present invention, its applications, and usage. Various modifications can be made as required.

### REFERENCE SIGNS LIST

10: texture atlas generation unit; 11: texture extension unit; 12: texture positioning unit; 20: rendering unit; 21: vertex processing unit; 22: pixel coordinate calculation unit; 23: coordinate conversion unit; 24: texture fetch unit; 30: main memory; 31: texture group; 32, 32d: position information; 33: polygon information; 40: VRAM; 41, 41a: texture atlas; 42: output image; 50: output unit; 100, 100a, 100b: texture mapping apparatus; 901: processor; 902: auxiliary storage device; 903: memory; 904: communication device; 905: input interface; 906: display interface; 907: input device; 908: display; 910: signal line; 911, 912: cable; 311, 311a, 311b, 311c, 311d: texture; 312, 312a, 312b, 312c, 312d: extended texture; 330: polygon information storage unit; 411: color information; 3110: texture to be rendered; 3111: rendered image; 9041: receiver; 9042: transmitter; S100: texture mapping process; S110: texture atlas generation process; S111: texture extension process; S112: texture positioning process; S120: rendering process; S121: vertex process; S122: pixel coordinate calculation process; S123: coordinate conversion process; S124: texture fetch process; S130: output process; S1121: positioning process; S1122: position information generation process; T1: vertex texture coordinates; T2: pixel-corresponding texture coordinates; T21: converted coordinates; V1: vertex coordinates; V2: coordinates

1-11. (canceled)

12. A texture mapping apparatus comprising:
processing circuitry to:
generate a texture atlas by combining a plurality of textures including a texture to be rendered which is used for rendering on a polygon being a polygonal region, and generate position information indicating a position, in the texture atlas, of the texture to be rendered;
store polygon information in which vertex coordinates, vertex texture coordinates, and a texture wrap mode indicating a method of mapping to the polygon are set, the vertex coordinates indicating a location of a vertex of the polygon in an output image composed of a plurality of pixels, the vertex texture coordinates indicating a location corresponding to the vertex coordinates in an image to be rendered on the polygon on a basis of the texture to be rendered;
detect pixel coordinates indicating pixels corresponding to the polygon in the output image on a basis of the polygon information, and calculate, as pixel-corresponding texture coordinates, coordinates corresponding to the pixel coordinates in the image to be rendered on the polygon; and
convert, using a conversion equation in accordance with the texture wrap mode, the pixel-corresponding texture coordinates to coordinates within an area including the texture to be rendered combined into the texture atlas, on a basis of the position information and the polygon information, and output the coordinates after being converted as converted coordinates.

13. The texture mapping apparatus according to claim 12, wherein the processing circuitry extracts color information from the texture atlas on a basis of the output converted coordinates, and fills in the pixels indicated by the pixel coordinates on a basis of the extracted color information.

14. The texture mapping apparatus according to claim 13,
wherein the processing circuitry
extends each texture of the plurality of textures,
generates the texture atlas by combining the textures extended by the texture extension unit, and generates position information indicating the position, in the texture atlas, of the texture to be rendered, and
converts, using the conversion equation in accordance with the texture wrap mode, the pixel-corresponding texture coordinates to the converted coordinates which are coordinates within an area of the texture to be rendered which has been extended, the area including the texture to be rendered, on the basis of the position information and the polygon information.

15. The texture mapping apparatus according to claim 14,
wherein the processing circuitry extends each texture of the plurality of textures by one pixel in each of an X-axis direction and a Y-axis direction.

16. The texture mapping apparatus according to claim 14,
wherein the processing circuitry extracts the color information by interpolating colors of a plurality of pixels surrounding each pixel indicated by the converted coordinates.

17. The texture mapping apparatus according to claim 12,
wherein the vertex texture coordinates in an image that is rendered on the polygon by repeating the texture to be rendered are set in the polygon information.

18. The texture mapping apparatus according to claim 12,
wherein the vertex texture coordinates in an image that is rendered on the polygon by clamping the texture to be rendered are set in the polygon information.

19. The texture mapping apparatus according to claim 13,
wherein the processing circuitry extracts, as the color information, information indicating a color of a pixel at a location indicated by the converted coordinates.

20. A texture mapping method of a texture mapping apparatus that performs rendering on a polygon being a polygonal region, using a texture to be rendered, the texture mapping apparatus having a polygon information storage to store polygon information in which vertex coordinates, vertex texture coordinates, and a texture wrap mode indicating a method of mapping to the polygon are set, the vertex coordinates indicating a location of a vertex of the polygon in an output image composed of a plurality of pixels, the vertex texture coordinates indicating a location corresponding to the vertex coordinates in an image to be rendered on the polygon on a basis of the texture to be rendered, the texture mapping method comprising:
generating a texture atlas by combining a plurality of textures including the texture to be rendered, and generating position information indicating a position, in the texture atlas, of the texture to be rendered;
detecting pixel coordinates indicating pixels corresponding to the polygon in the output image on a basis of the polygon information, and calculating, as pixel-corresponding texture coordinates, coordinates corresponding to the pixel coordinates in the image to be rendered on the polygon; and
converting, using a conversion equation in accordance with the texture wrap mode, the pixel-corresponding texture coordinates to coordinates within an area including the texture to be rendered combined into the texture atlas, on a basis of the position information and the polygon information, and outputting the coordinates after being converted as converted coordinates.

21. A non-transitory computer readable medium storing a program for a texture mapping apparatus that performs rendering on a polygon being a polygonal region, using the texture to be rendered, the texture mapping apparatus having a polygon information storage to store polygon information in which vertex coordinates, vertex texture coordinates, and a texture wrap mode indicating a method of mapping to the polygon are set, the vertex coordinates indicating a location of a vertex of the polygon in an output image composed of a plurality of pixels, the vertex texture coordinates indicating a location corresponding to the vertex coordinates in an image to be rendered on the polygon on a basis of the texture to be rendered, the program causing a computer to execute:
a texture atlas generation process to generate a texture atlas by combining a plurality of textures including the texture to be rendered, and generate position information indicating a position, in the texture atlas, of the texture to be rendered;
a pixel coordinate calculation process to detect pixel coordinates indicating pixels corresponding to the polygon in the output image on a basis of the polygon information, and calculate, as pixel-corresponding texture coordinates, coordinates corresponding to the pixel coordinates in the image to be rendered on the polygon; and
a coordinate conversion process to convert, using a conversion equation in accordance with the texture wrap mode, the pixel-corresponding texture coordinates to coordinates within an area including the texture to be rendered combined into the texture atlas, on a basis of the position information and the polygon information, and output the coordinates after being converted as converted coordinates.
